(19) United States
(12) Patent Application Publication
(10) Pub. No.: US 2025/0035876 A1
(43) Pub. Date: Jan. 30, 2025

(54) FEED-THROUGH STRUCTURE

(71) Applicant: NEC Corporation, Minato-ku, Tokyo (JP)

(72) Inventors: Masayoshi Tani, Kanagawa (JP); Toshihide Nagasawa, Tokyo (JP); Koichi Akano, Kanagawa (JP)

(73) Assignee: NEC Corporation, Minato-ku, Tokyo (JP)

(21) Appl. No.: 18/716,227

(22) PCT Filed: Dec. 22, 2021
(86) PCT No.: PCT/JP2021/047638

§ 371 Date: Jun. 4, 2024

(51) Int. Cl. G02B 6/44

(52) U.S. Cl. CPC G02B 6/44775

(57) ABSTRACT

A feed-through structure includes: an end surface plate of a pressure-resistant housing; a power feed pipe configured to penetrate the end surface plate; a cup configured to be attached to the end surface plate and cover the power feed pipe; and an insulating liquid filled in the internal space of the cup. The feed-through structure is applied to, for example, an optical submarine repeater. The insulating liquid is typically an insulating oil or a fluorine-based inert liquid. The end surface plate is typically composed of beryllium copper.

### TECHNICAL FIELD

The present disclosure relates to a feed-through structure.

### BACKGROUND ART

Patent Literature 1 discloses an optical submarine repeater installed on the seabed. The optical submarine repeater includes a pressure-resistant housing being capable of resisting a water pressure in the deep sea, an optical signal amplifier accommodated in the pressure-resistant housing, and an insulating liquid filled in the pressure-resistant housing. Further, in Patent Literature 1, it is mentioned that usage amount of the insulating liquid can be conserved by, for example, filling the insulating liquid only in a portion where a high dielectric strength is required, such as the optical signal amplifier, instead of filling the entire internal space of the pressure-resistant housing with the insulating liquid.

### CITATION LIST

### Patent Literature

Patent Literature 1: Japanese Unexamined Patent Application Publication No. 2001-327061

### SUMMARY OF INVENTION

### Technical Problem

However, while proposing filling an insulating liquid only in a portion where a high dielectric strength is required, Patent Literature 1 does not disclose any specific configuration thereof.

An object of the present disclosure is to provide a technique for achieving insulation between an end surface plate of a pressure-resistant housing and a power feed pipe by using a small amount of insulating liquid.

### Solution to Problem

According to an aspect of the present disclosure, provided is a feed-through structure including: an end surface plate of a pressure-resistant housing; a power feed pipe configured to penetrate the end surface plate; a cup configured to be attached to the end surface plate and cover the power feed pipe; and an insulating liquid filled in an internal space of the cup.

### Advantageous Effects of Invention

According to the present disclosure, it is possible to achieve insulation between an end surface plate of a pressure-resistant housing and a power feed pipe by using a small amount of insulating liquid.

### BRIEF DESCRIPTION OF DRAWINGS

FIG. 1 is a schematic diagram illustrating a feed-through structure (first example embodiment);

FIG. 2 is a front cross-sectional diagram of an optical repeater (second example embodiment);

FIG. 3 is a perspective diagram of a feed-through structure (second example embodiment);

FIG. 4 is a cross-sectional diagram of the feed-through structure (second example embodiment);

FIG. 5 is an enlarged diagram of a portion A of FIG. 4 (second example embodiment);

FIG. 6 is a cross-sectional diagram of a feed-through structure (third example embodiment); and

FIG. 7 is an enlarged diagram of a portion B of FIG. 7 (third example embodiment).

### EXAMPLE EMBODIMENT

### First Example Embodiment

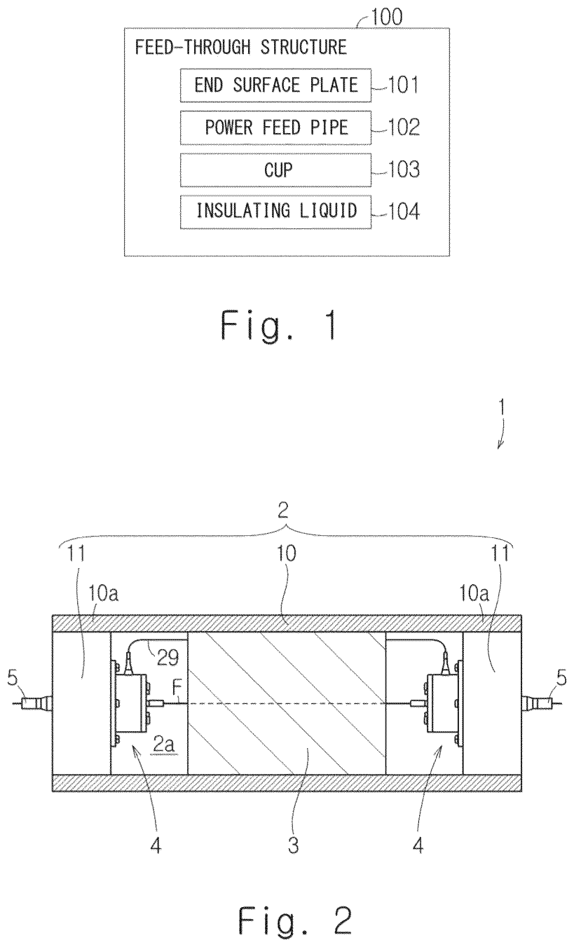

Hereinafter, a first example embodiment of the present disclosure is described with reference to FIG. 1. FIG. 1 illustrates a schematic diagram of a feed-through structure 100.

As illustrated in FIG. 1, the feed-through structure 100 includes an end surface plate 101 of a pressure-resistant housing, a power feed pipe 102 that penetrates the end surface plate 101, a cup 103 attached to the end surface plate 101 and that covers the power feed pipe 102, and an insulating liquid 104 filled in the internal space of the cup 103. According to the above-described configuration, insulation between the end surface plate 101 of the pressure-resistant housing and the power feed pipe 102 may be achieved by using a small amount of the insulating liquid 104.

### Second Example Embodiment

Next, a second example embodiment is described with reference to FIGS. 2 to 5.

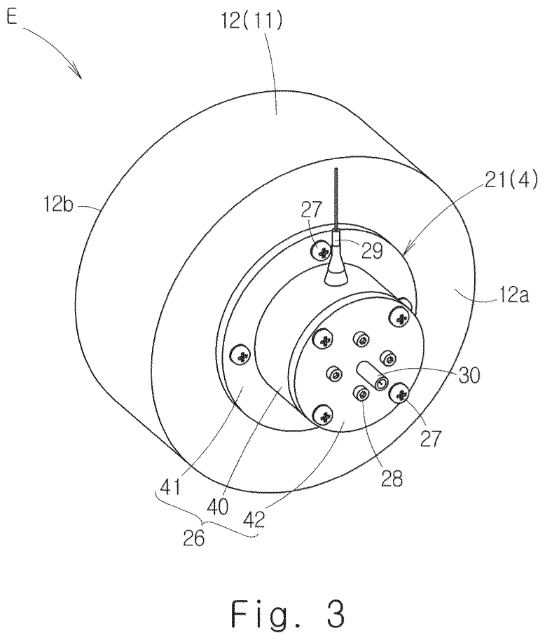

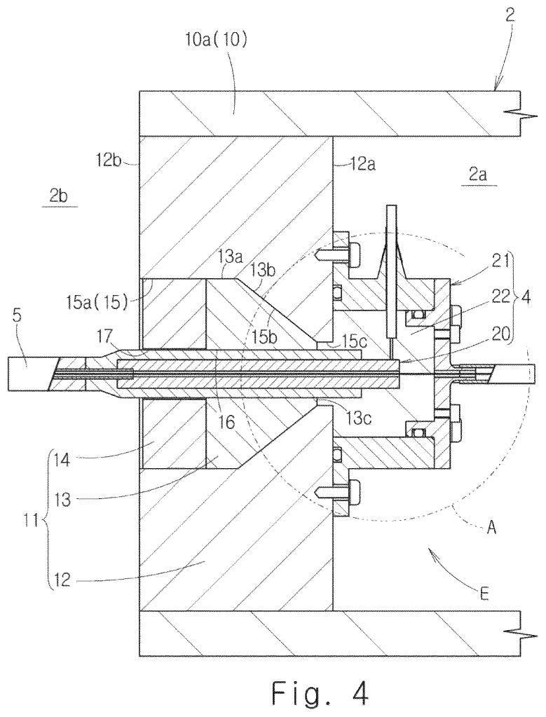

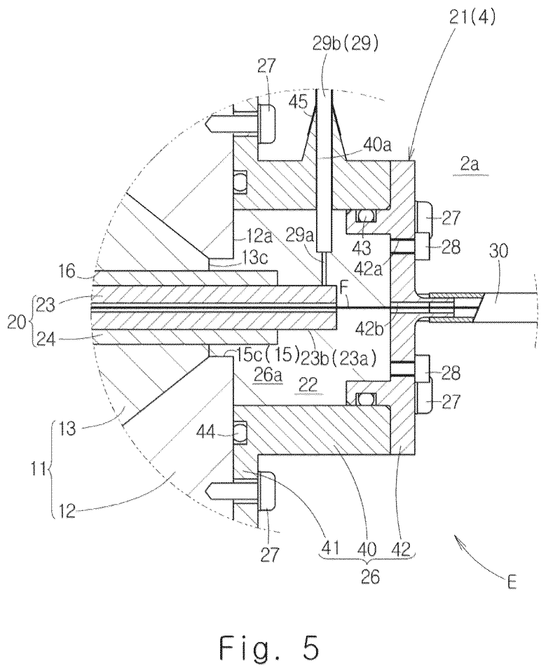

FIG. 2 is a cross-sectional diagram of an optical submarine repeater 1. FIG. 3 illustrates a perspective diagram of a feed-through structure E. FIG. 4 illustrates a cross-sectional diagram of the feed-through structure E. FIG. 5 is an enlarged diagram of a portion A of FIG. 4.

As illustrated in FIG. 2, the optical submarine repeater 1 includes a pressure-resistant housing 2, an internal unit 3, two feed-throughs 4, and two tail cables 5.

The pressure-resistant housing 2 includes a hollow-cylindrical pressure-resistant housing main body 10 and two end surface plates 11. The two end surface plates 11 are attached to an open end 10a of the pressure-resistant housing main body 10. The two end surface plates 11 close the open end 10a of the pressure-resistant housing main body 10.

The internal unit 3 typically includes an optical signal amplifier configured to amplify an optical signal. The internal unit 3 is accommodated in the internal space 2a of the pressure-resistant housing 2. The internal unit 3 operates by power supplied from a submarine cable connected to the tail cables 5.

Each feed-through 4 is provided on each end surface plate 11 and connects each tail cable 5 to the internal unit 3.

Hereinafter, a feed-through 4 being one of the two feed-throughs 4, and an end surface plate 11 and a tail cable 5 which are associated with such feed-through 4 is described, and description relating to the other of the two feed-throughs 4 is omitted.

As illustrated in FIGS. 3 and 4, the end surface plate 11 is formed in a solid cylindrical shape. As illustrated in FIG. 4, the end surface plate 11 is provided radially inward of the relative open end 10a of the pressure-resistant housing main body 10. The end surface plate 11 includes an end surface plate main body 12, a conical body 13, and a nut 14. Each of the end surface plate main body 12, the conical body 13, and the nut 14 is configured of a conductive metal, for example, beryllium copper (BeCu).

The end surface plate main body 12 includes an inner surface 12a defining the internal space 2a of the pressure-resistant housing 2, and an outer surface 12b facing away from the inner surface 12a. A through-hole 15 extending in the axial direction of the pressure-resistant housing 2 is formed in the end surface plate main body 12. Hereinafter, when simply referred to as the axial direction, it means the axial direction of the pressure-resistant housing 2. Similarly, when simply referred to as the radial direction, it means the radial direction of the pressure-resistant housing 2. The through-hole 15 opens into the inner surface 12a and the outer surface 12b. The inner peripheral surface of the through-hole 15 includes a high-pressure-side straight inner peripheral surface 15a, a tapered inner peripheral surface 15b, and a low-pressure-side straight inner peripheral surface 15c. The high-pressure-side straight inner peripheral surface 15a, the tapered inner peripheral surface 15b, and the low-pressure-side straight inner peripheral surface 15c are continuous in this order from the outer surface 12b toward the inner surface 12a. The high-pressure-side straight inner peripheral surface 15a extends parallel to the axial direction. The tapered inner peripheral surface 15b decreases in diameter toward the internal space 2a of the pressure-resistant housing 2. The low-pressure-side straight inner peripheral surface 15c extends parallel to the axial direction.

The conical body 13 is disposed in the through-hole 15 of the end surface plate main body 12. The conical body 13 has a straight outer peripheral surface 13a, a tapered outer peripheral surface 13b, and a leading-end surface 13c. The straight outer peripheral surface 13a, the tapered outer peripheral surface 13b, and the leading-end surface 13c are continuous in this order from the outer surface 12b toward the inner surface 12a. The straight outer peripheral surface 13a extends parallel to the axial direction, and opposes the high-pressure side straight inner peripheral surface 15a in the radial direction. The outer diameter of the straight outer peripheral surface 13a is set to be slightly smaller than the inner diameter of the high-pressure-side straight inner peripheral surface 15a. The tapered outer peripheral surface 13b decreases in diameter toward the internal space 2a of the pressure-resistant housing 2. The tapered outer peripheral surface 13b opposes the tapered inner peripheral surface 15b in the radial direction. The leading-end surface 13c is orthogonal to the axial direction. The outer peripheral edge of the leading-end surface 13c is positioned at a boundary between the tapered inner peripheral surface 15b and the low-pressure side straight inner peripheral surface 15c of the through-hole 15. Therefore, the leading-end surface 13c is not covered by the end surface plate main body 12 in the axial direction. A through-hole 16 extending in the axial direction is formed in the conical body 13.

The nut 14 is disposed in the through-hole 15 of the end surface plate main body 12. The nut 14 is arranged on the high-pressure side as viewed from the conical body 13. By engaging the nut 14 with a female thread (not illustrated) formed on the high-pressure side straight inner peripheral surface 15a of the through-hole 15 of the end surface plate main body 12, the tapered outer peripheral surface 13b of the conical body 13 is pressed against the tapered inner peripheral surface 15b of the through-hole 15. A through-hole 17 extending in the axial direction is formed in the nut 14.

As illustrated in FIG. 4, the feed-through 4 includes a penetration unit 20, a cup unit 21, and an insulating liquid 22.

As illustrated in FIG. 5, the penetration unit 20 includes a power feed pipe 23 and an insulation coating 24. The power feed pipe 23 is a conductive metal pipe through which the optical fiber F passes, and is composed of, for example, beryllium copper (BeCu). The insulation coating 24 is, for example, an insulating resin such as polyethylene or polyurethane, and covers the outer peripheral surface of the power feed pipe 23. The penetration unit 20 protrudes from the inner surface 12a of the end surface plate main body 12 toward the internal space 2a. The outer peripheral surface 23b of the leading end 23a on the internal space 2a side of the power feed pipe 23 is exposed, without being covered by the insulation coating 24. The penetration unit 20 passes through the through-hole 15 of the end surface plate main body 12. As illustrated in FIG. 4, the penetration unit 20 is arranged in such a way as to pass through the through-hole 16 of the conical body 13 and the through-hole 17 of the nut 14. One end of the penetration unit 20 is exposed to the internal space 2a of the pressure-resistant housing 2, and the other end thereof is exposed to the external space 2b of the pressure-resistant housing 2.

As illustrated in FIGS. 3 and 5, the cup unit 21 includes a cup main body 26, a plurality of fixing bolts 27, a plurality of drain bolts 28, a power feed line 29, and an optical fiber protection tube 30.

The cup main body 26 is a specific example of the cup. The cup main body 26 is a bottomed cylinder-shaped insulating resin including a hollow cylindrical portion 40, a flange 41, and an axially opposing portion 42.

As illustrated in FIG. 5, the hollow cylindrical portion 40 has a hollow cylindrical shape and extends parallel to the axial direction. The hollow cylindrical portion 40 is disposed so as to oppose the penetration unit 20 in the radial direction. The hollow cylindrical portion 40 is disposed in such a way as to annularly cover the penetration unit 20. The hollow cylindrical portion 40 is disposed in such a way as to annularly cover the exposed leading end 23a of the power feed pipe 23.

The flange 41 protrudes in an annular shape radially outward from an end portion of the hollow cylindrical portion 40 on the end surface plate 11 side. The hollow cylindrical portion 40 and the flange 41 are integrally formed.

The axially opposing portion 42 is arranged in such a way as to be opposed, in the axial direction, to the leading end 23a of the power feed pipe 23 of the penetration unit 20, and to close the open end of the hollow cylindrical portion 40. A plurality of filling holes 42a are formed in the axially opposing portion 42. The drain bolt 28 is attached to each filling hole 42a. The axially opposing portion 42 is fixed to the hollow cylindrical portion 40 by a plurality of fixing bolts 27. An annular O-ring 43 is provided between the axially opposing portion 42 and the hollow cylindrical portion 40. This ensures watertightness between the axially opposing portion 42 and the hollow cylindrical portion 40.

The cup main body 26 is attached to the inner surface 12a of the end surface plate main body 12 by a plurality of fixing bolts 27 penetrating the flange 41. An O-ring 44 extending in an annular shape is provided between the hollow cylindrical portion 40 and the inner surface 12a of the end surface plate main body 12. This ensures watertightness between the hollow cylindrical portion 40 and the inner surface 12a of the end surface plate main body 12.

The axially opposing portion 42 is opposed, in the axial direction, to the end surface plate main body 12, the conical body 13, and the penetration unit 20. Specifically, the axially opposing portion 42 is opposed, in the axial direction, to the hollow cylindrical portion 40, the inner surface 12a of the end surface plate main body 12, the leading-end surface 13c of the conical body 13, the leading end 23a of the power feed pipe 23 of the penetration unit 20, and the insulation coating 24. Accordingly, an internal space 26a of the cup main body 26 is defined, in the axial direction, by the axially opposing portion 42, the inner surface 12a of the end surface plate main body 12, the leading-end surface 13c of the conical body 13, the leading end 23a of the power feed pipe 23 of the penetration unit 20, and the insulation coating 24. The internal space 26a of the cup main body 26 is defined, in the radial direction, by the hollow cylindrical portion 40.

The power feed line 29 includes a core wire 29a and an insulation coating 29b covering the core wire 29a. The core wire 29a of the power feed line 29 is connected, by brazing, to the outer peripheral surface 23b of the leading end 23a of the power feed pipe 23 exposed in the internal space 26a of the cup main body 26. The power feed line 29 passes through a power feed draw-out hole 40a provided in the hollow cylindrical portion 40 and is drawn out from the internal space 26a of the cup main body 26. The watertightness between the power feed line 29 and the hollow cylindrical portion 40 is ensured by a self-fusing tape 45.

The optical fiber protection tube 30 protects the optical fiber F drawn out from an optical fiber draw-out hole 42b provided in the axially opposing portion 42.

The insulating liquid 22 is filled in the internal space 26a of the cup main body 26. The insulating liquid 22 is typically an insulating oil or a fluorine-based inert liquid. The insulating liquid 22 is filled in the internal space 26a of the cup main body 26 through any one of the filling holes 42a in the axially opposing portion 42. In addition, vacuum defoaming of the insulating liquid 22 may be performed by using any one of the filling holes 42a in the axially opposing portion 42. As described above, the insulating liquid 22 is filled in the internal space 26a of the cup main body 26, thereby ensuring insulation between the leading end 23a of the power feed pipe 23 exposed in the internal space 26a of the cup main body 26 and the inner surface 12a of the end surface plate main body 12.

In the present example embodiment, the feed-through structure E includes at least the end surface plate 11, the power feed pipe 23, the cup main body 26, and the insulating liquid 22.

Next, a method for manufacturing the feed-through structure E is described.

First, the power feed pipe 23 of the penetration unit 20 and the conical body 13 of the end surface plate 11 are set in a mold, molten resin is supplied into the mold, and thereby the insulation coating 24 is formed between the power feed pipe 23 and the conical body 13. As a result, the penetration unit 20 and the conical body 13 are integrated. Next, the tail cable 5 is connected to the penetration unit 20. Then, the penetration unit 20 and the conical body 13 are inserted into the through-hole 15 of the end surface plate main body 12, and the nut 14 is engaged with the high-pressure side straight inner peripheral surface 15a of the through-hole 15. This ensures a watertightness between the conical body 13 and the end surface plate main body 12 in an annular shape. Next, the hollow cylindrical portion 40 and the flange 41 of the cup main body 26 are attached to the inner surface 12a of the end surface plate main body 12. Then, the core wire 29a of the power feed line 29, which is disposed in the power feed draw-out hole 40a of the hollow cylindrical portion 40 in advance, is brazed to the power feed pipe 23 of the penetration unit 20. Then, the optical fiber F is drawn out from the optical fiber draw-out hole 42b in the axially opposing portion 42, and then the axially opposing portion 42 is attached to the hollow cylindrical portion 40. Then, the insulating liquid 22 is filled into the internal space 26a of the cup main body 26.

The second example embodiment of the present disclosure has been described above, and the above-described example embodiment has the following features.

That is, the feed-through structure E includes an end surface plate 11 of the pressure-resistant housing 2, the power feed pipe 23 that penetrates the end surface plate 11, the cup main body 26 (cup) that is attached to the end surface plate 11 and covers the power feed pipe 23, and the insulating liquid 22 that is filled in the internal space 26a of the cup main body 26. According to the above-described configuration, the insulation between the end surface plate 11 of the pressure-resistant housing 2 and the power feed pipe 23 may be achieved by using a small amount of the insulation liquid 22.

Further, the cup main body 26 has a bottomed cylindrical shape including a hollow cylindrical portion 40 that annularly covers the power feed pipe 23, and an axially opposing portion 42 that opposes the power feed pipe 23 in the axial direction. The power feed pipe 23 and the axially opposing portion 42 are opposed to each other, in the axial direction, with the insulating liquid 22 interposed therebetween. According to the above-described configuration, insulation between the power feed pipe 23 and the axially opposing portion 42 is ensured.

The hollow cylindrical portion 40 is formed in a watertight manner relative to the end surface plate 11. According to the above-described configuration, watertightness between the hollow cylindrical portion 40 and the end surface plate 11 is ensured.

The end surface plate 11 and the axially opposing portion 42 of the cup main body 26 are opposed to each other, in the axial direction, with the insulating liquid 22 interposed therebetween. According to the above-described configuration, insulation between the end surface plate 11 and the axially opposing portion 42 is ensured.

The feed-through structure E further includes a power feed line 29 connected to the power feed pipe 23. The power feed line 29 penetrates the insulating liquid 22 and the cup main body 26. According to the above-described configuration, insulation between the power feed line 29 and the cup main body 26 is ensured in the internal space 26a of the cup main body 26.

### Third Example Embodiment

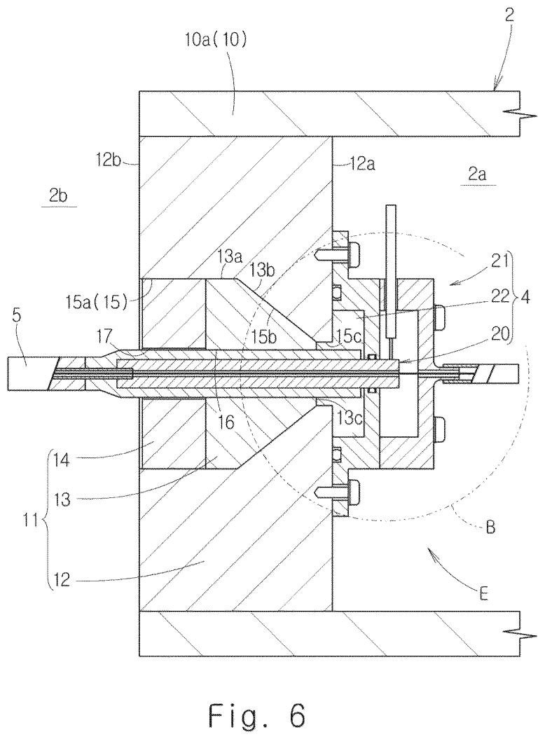

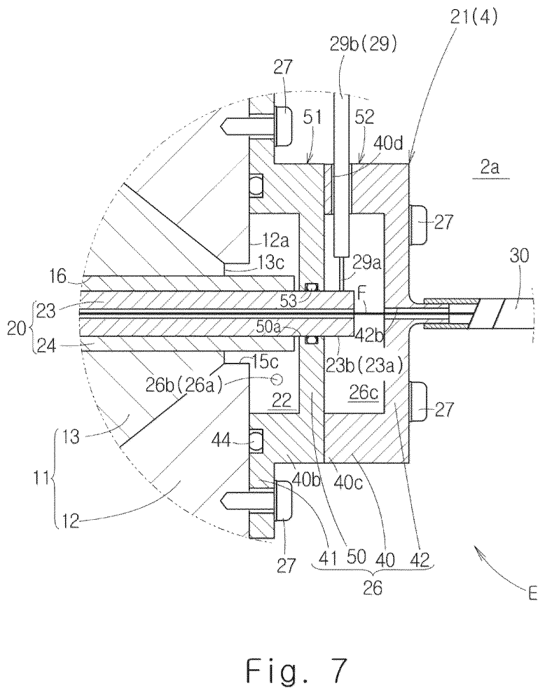

Hereinafter, a third example embodiment of the present disclosure is described with reference to FIGS. 6 and 7. Hereinafter, the present example embodiment is mainly described in terms of differences from the second example embodiment, and redundant description is omitted. In FIGS. 6 and 7, a component corresponding to that described in the second example embodiment is denoted by the same reference sign. FIG. 6 illustrates a cross-sectional diagram of a feed-through structure E. FIG. 7 is an enlarged diagram of a portion B of FIG. 6.

As illustrated in FIGS. 6 and 7, the feed-through structure E of the present example embodiment includes an end surface plate 11 of a pressure-resistant housing 2, similarly to the second example embodiment. As illustrated in FIGS. 6 and 7, the feed-through structure E of the present example embodiment includes a power feed pipe 23 that penetrates the end surface plate 11, a cup main body 26 (cup) that is attached to the end surface plate 11 and covers the power feed pipe 23, and an insulating liquid 22 that is filled in the internal space 26a of the cup main body 26. According to the above-described configuration, insulation between the end surface plate 11 of the pressure-resistant housing 2 and the power feed pipe 23 may be achieved by using a small amount of the insulation liquid 22.

As illustrated in FIG. 7, in the present example embodiment, the cup main body 26 is a bottomed cylinder-shaped insulating resin including a hollow cylindrical portion 40 that annularly covers the power feed pipe 23, and an axially opposing portion 42 that opposes the power feed pipe 23 in the axial direction. The cup main body 26 further includes a partition wall 50 that divides the internal space 26a into a first space 26b that is relatively close to the end surface plate 11 and a second space 26c that is relatively far from the end surface plate 11 in the axial direction. The hollow cylindrical portion 40 includes a first cylindrical portion 40b that defines the first space 26b in the radial direction, and a second cylindrical portion 40c that defines the second space 26c in the radial direction.

A through-hole 50a is formed in the partition wall 50. The power feed pipe 23 is disposed in such a way as to penetrate the partition wall 50. An O-ring 53 is provided between the power feed pipe 23 and the inner peripheral surface of the through-hole 50a. This ensures watertightness between the power feed pipe 23 and the through-hole 50a in the partition wall 50.

An outer peripheral surface 23b of the power feed pipe 23 is exposed in the first space 26b. The outer peripheral surface 23b of the power feed pipe 23 is exposed in the second space 26c.

The insulating liquid 22 is filled in the first space 26b and is not filled in the second space 26c. This ensures insulation between the outer peripheral surface 23b of the power feed pipe 23 exposed in the first space 26b and an inner surface 12a of an end surface plate main body 12.

A core wire 29a of a power feed line 29 is connected, by brazing, to the outer peripheral surface 23b of the leading end 23a of the power feed pipe 23, in the second space 26c. The power feed line 29 is drawn out from a power feed draw-out hole 40d formed in the second cylindrical portion 40c of the hollow cylindrical portion 40 of the cup main body 26.

As described above, since the power feed line 29 is connected to the power feed pipe 23 in the second space 26c, it is not necessary to ensure the watertightness between the power feed line 29 and the second cylindrical portion 40c of the hollow cylindrical portion 40 in the power feed draw-out hole 40d. Similarly, it is not necessary to ensure watertightness between the optical fiber F and an optical fiber draw-out hole 42b of the axially opposing portion 42. Therefore, a complicated configuration for ensuring watertightness may be omitted.

In the present example embodiment, the cup main body 26 is configured by connecting, in the axial direction, a first cup portion 51 made of an insulating resin and a second cup portion 52 made of an insulating resin. The first cup portion 51 has a bottomed cylindrical shape forming the first space 26b, and includes the first cylindrical portion 40b, the partition wall 50, and a flange 41. The second cup portion 52 has a bottomed cylindrical shape forming the second space 26c, and includes the second cylindrical portion 40c and the axially opposing portion 42.

The first cup portion 51 is attached to the inner surface 12a of the end surface plate main body 12 by a plurality of fixing bolts 27 penetrating the flange 41.

The second cup portion 52 is connected to the first cup portion 51 by a plurality of fixing bolts 27.

Next, a method for manufacturing the feed-through structure E is described.

First, the power feed pipe 23 of a penetration unit 20 and a conical body 13 of the end surface plate 11 is set in a mold, molten resin is supplied into the mold, and thereby an insulation coating 24 is formed between the power feed pipe 23 and the conical body 13. As a result, the penetration unit 20 and the conical body 13 are integrated. Next, the tail cable 5 is connected to the penetration unit 20. Then, the penetration unit 20 and the conical body 13 are inserted into a through-hole 15 of the end surface plate main body 12, and a nut 14 is engaged with a high-pressure side straight inner peripheral surface 15a of the through-hole 15. This ensures watertightness between the conical body 13 and the end surface plate main body 12 in an annular shape. The above description is similar to that of the second example embodiment.

Next, the first cup portion 51 is attached to the inner surface 12a of the end surface plate main body 12 by using a plurality of fixing bolts 27. At this time, the power feed pipe 23 passes through the through-hole 50a of the partition wall 50 of the first cup portion 51. Next, the first space 26b is filled with the insulating liquid 22 via the filling hole provided in the partition wall 50. Then, the core wire 29a of the power feed line 29 is brazed to the power feed pipe 23 of the penetration unit 20, and the power feed line 29 is drawn out from the power feed draw-out hole 40d in the hollow cylindrical portion 40, and the optical fiber F is drawn out from the optical fiber draw-out hole 42b of the axially opposing portion 42. In this state, the second cup portion 52 is attached to the first cup portion 51 by using a plurality of fixing bolts 27.

The third example embodiment has been described above, and the above-described example embodiment has the following features.

That is, the cup main body 26 (cup) has a bottomed cylindrical shape including the hollow cylindrical portion 40 that annularly covers the power feed pipe 23, and the axially opposing portion 42 that opposes the power feed pipe 23 in the axial direction. The cup main body 26 further includes the partition wall 50 that divides, in the axial direction, the internal space 26a into the first space 26b and the second space 26c. The power feed pipe 23 is disposed so as to penetrate the partition wall 50. The power feed pipe 23 is exposed in the first space 26b and is exposed in the second space 26c. The insulating liquid 22 is filled in the first space 26b, and is not filled in the second space 26c. According to the above-described configuration, the insulation between the end surface plate 11 of the pressure-resistant housing 2 and the power feed pipe 23 may be achieved by using a small amount of the insulating liquid 22.

Further, the hollow cylindrical portion 40 is formed in a watertight manner relative to the end surface plate 11. According to the above-described configuration, watertightness between the hollow cylindrical portion 40 and the end surface plate 11 is ensured.

The end surface plate 11 and the partition wall 50 are opposed to each other, in the axial direction, with the insulating liquid 22 interposed therebetween. According to the above-described configuration, insulation between the end surface plate 11 and the partition wall 50 is ensured.

The feed-through structure E further includes the power feed line 29 connected to the power feed pipe 23 in the second space 26c. The power feed line 29 penetrates the cup main body 26. According to the above-described configuration, it is possible to avoid a complicated configuration necessary for ensuring the watertightness between the cup main body 26 and the power feed line 29.

The cup main body 26 is configured by connecting the bottomed cylindrical first cup portion 51 forming the first space 26b and the bottomed cylindrical second cup portion 52 forming the second space 26c in the axial direction. According to the above-described configuration, since the core wire 29a of the power feed line 29 may be connected to the outer peripheral surface 23b of the leading end 23a of the power feed pipe 23 after the first space 26b is filled with the insulating liquid 22, the assembling workability is good.

Although the example embodiments according to the present disclosure have been described above, the above-described example embodiments may be modified as follows.

In each of the above-described example embodiments, the feed-through structure E is assumed to be applied to the optical submarine repeater 1. However, alternatively, the feed-through structure E may also be applied to an optical lakebed repeater installed on a lakebed.

### INDUSTRIAL APPLICABILITY

The present disclosure is applicable to general electronic devices installed on the seabed or a lakebed.

### REFERENCE SIGNS LIST

1 OPTICAL SUBMARINE REPEATER
2 PRESSURE-RESISTANT HOUSING
2a INTERNAL SPACE
2b EXTERNAL SPACE
3 INTERNAL UNIT
4 FEED-THROUGH
5 TAIL CABLE
10 PRESSURE-RESISTANT HOUSING MAIN BODY
10a OPEN END
11 END SURFACE PLATE
12 END SURFACE PLATE MAIN BODY
12a INNER SURFACE
12b OUTER SURFACE
13 CONICAL BODY
13a STRAIGHT OUTER PERIPHERAL SURFACE
13b TAPERED OUTER PERIPHERAL SURFACE
13c LEADING-END SURFACE
14 NUT
15 THROUGH-HOLE
15a HIGH-PRESSURE-SIDE STRAIGHT INNER PERIPHERAL SURFACE
15b TAPERED INNER PERIPHERAL SURFACE
15c LOW-PRESSURE-SIDE STRAIGHT INNER PERIPHERAL SURFACE
16 THROUGH-HOLE
17 THROUGH-HOLE
20 PENETRATION UNIT
21 CUP UNIT
22 INSULATING LIQUID
23 POWER FEED PIPE
23a LEADING END
23b OUTER PERIPHERAL SURFACE
24 INSULATION COATING
26 CUP MAIN BODY
26a INTERNAL SPACE
26b FIRST SPACE
26c SECOND SPACE
27 FIXING BOLT
28 DRAIN BOLT
29 POWER FEED LINE
29a CORE WIRE
29b INSULATION COATING
30 OPTICAL FIBER PROTECTION TUBE
40 HOLLOW CYLINDRICAL PORTION
40a POWER FEED DRAW-OUT HOLE
40b FIRST CYLINDRICAL PORTION
40c SECOND CYLINDRICAL PORTION
40d POWER FEED DRAW-OUT HOLE
41 FLANGE
42 AXIALLY OPPOSING PORTION
42a FILLING HOLE
42b OPTICAL FIBER DRAW-OUT HOLE
43 O-RING
44 O-RING
45 SELF-FUSING TAPE
50 PARTITION WALL
50a THROUGH-HOLE
51 FIRST CUP PORTION
52 SECOND CUP PORTION
53 O-RING
E FEED-THROUGH STRUCTURE
F OPTICAL FIBER

What is claimed is:

1. A feed-through structure comprising:
an end surface plate of a pressure-resistant housing;
a power feed pipe configured to penetrate the end surface plate;
a cup configured to be attached to the end surface plate and cover the power feed pipe; and
an insulating liquid filled in an internal space of the cup.

2. The feed-through structure according to claim 1, wherein
the cup has a bottomed cylindrical shape including a hollow cylindrical portion that annularly covers the power feed pipe, and an axially opposing portion that opposes the power feed pipe in an axial direction, and
the power feed pipe and the axially opposing portion are opposed to each other, in the axial direction, with the insulating liquid interposed therebetween.

3. The feed-through structure according to claim 2, wherein the hollow cylindrical portion is formed in a watertight manner relative to the end surface plate.

4. The feed-through structure according to claim 2, wherein the end surface plate and the axially opposing portion of the cup are opposed to each other, in the axial direction, with the insulating liquid interposed therebetween.

5. The feed-through structure according to claim 1, further comprising a power feed line connected to the power feed pipe,
wherein the power feed line penetrates the insulating liquid and the cup.

6. The feed-through structure according to claim 1, wherein
the cup has a bottomed cylindrical shape including a hollow cylindrical portion that annularly covers the power feed pipe, and an axially opposing portion that opposes the power feed pipe in an axial direction,
the cup further includes a partition wall configured to divide the internal space into a first space relatively close to the end surface plate and a second space relatively far from the end surface plate in the axial direction,
the power feed pipe is disposed in such a way as to penetrate the partition wall, is exposed in the first space, and is also exposed in the second space, and
the insulating liquid is filled in the first space, and is not filled in the second space.

7. The feed-through structure according to claim 6, wherein the hollow cylindrical portion is formed in a watertight manner relative to the end surface plate.

8. The feed-through structure according to claim 6, wherein the end surface plate and the partition wall are opposed to each other, in the axial direction, with the insulating liquid interposed therebetween.

9. The feed-through structure according to claim 6, further comprising a power feed line connected to the power feed pipe in the second space,
wherein the power feed line penetrates the cup.

10. The feed-through structure according to claim 6, wherein the cup is configured by connecting a bottomed cylindrical shaped first cup portion forming the first space and a bottomed cylindrical shaped second cup portion forming the second space in the axial direction.
